(19) United States
(12) Patent Application Publication
(10) Pub. No.: US 2025/0110215 A1
(43) Pub. Date: Apr. 3, 2025

(54) SENSOR ASSEMBLY

(71) Applicant: GM GLOBAL TECHNOLOGY OPERATIONS LLC, Detroit, MI (US)

(72) Inventors: Ratandeep Singh Kukreja, Auburn Hills, MI (US); Nicholas Paul William Pieczonka, Windsor (CA); William Reginald Collin, Dearborn, MI (US)

(21) Appl. No.: 18/374,422

(22) Filed: Sep. 28, 2023

(51) Int. Cl. G01S 7/481; B08B 1/00; B08B 1/04

(52) U.S. Cl. CPC G01S 7/4813; B08B 1/143; B08B 1/32

(57) ABSTRACT

A sensor assembly including: a rotatable mount; transmitter components and receiver components supported by the rotatable mount so as to rotate with the rotatable mount; a motor configured to rotate the rotatable mount by rotating a shaft connected to the rotatable mount; a bearing configured to support the shaft; and a contaminant trap between the bearing and each of the transmitter components and the receiver components, the contaminant trap configured to capture contaminants to restrict passage of contaminants from the bearing to the transmitter components and the receiver components.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a sensor assembly.

Sensor assemblies often include a transmitter and a receiver, which respectively transmit and receive energy. For example, a light detection and ranging (LiDAR) sensor assembly typically includes a laser, which transmits a light beam, and a receiver, which receives the light beam after it has been reflected back to the LiDAR sensor assembly. A LiDAR sensor assembly further includes various mirrors and lenses for directing and focusing light.

### SUMMARY

The present disclosure provides for, in various features, a sensor assembly including: a rotatable mount; transmitter components and receiver components supported by the rotatable mount so as to rotate with the rotatable mount; a motor configured to rotate the rotatable mount by rotating a shaft connected to the rotatable mount; a bearing configured to support the shaft; and a contaminant trap between the bearing and each of the transmitter components and the receiver components, the contaminant trap configured to capture contaminants to restrict passage of contaminants from the bearing to the transmitter components and the receiver components.

In further features, the transmitter components include at least one of a light beam transmitter, a mirror, and a lens.

In further features, the receiver components include at least one of a receiver, a mirror, and a lens.

In further features, the sensor assembly is configured as a light detection and ranging (LiDAR) sensor.

In further features, the contaminant trap extends around the shaft.

In further features, the contaminant trap includes a sorbent material configured to trap vapor released from lubricant included with the bearing.

In further features, the contaminant trap includes at least one of activated carbon, alumina, polyurethane, polyethylene, polypropylene, and a graphitic material.

In further features, the present disclosure includes a window, the rotatable mount is seated behind the window; and a cleaning member mounted to an outer surface of the rotatable mount and in contact with an inner surface of the window such that as the rotatable mount rotates the cleaning member slides along the inner surface of the window to clean the window.

In further features, the cleaning member includes a cleaning pad configured to remove build-up on the inner surface of contaminants released from the bearing.

The present disclosure further provides for, in various features, a light detection and ranging (LiDAR) sensor assembly including: a window; a rotatable mount configured to rotate behind the window; a mirror and a lens supported by the rotatable mount; a motor configured to rotate the rotatable mount by rotating a shaft connected to the rotatable mount; a bearing configured to support the shaft; and a contaminant trap extending around the shaft between the bearing and the rotatable mount, the contaminant trap configured to capture contaminants released from the bearing to restrict passage of the contaminants from the bearing to at least one of the mirror and the lens.

In further features, the present disclosure includes a light transmitter and a light receiver mounted to the rotatable mount.

In further features, the contaminant trap includes a sorbent material configured to trap vapor released from lubricant included with the bearing, the sorbent material including at least one of: activated carbon, alumina, polyurethane, polyethylene, polypropylene, and a graphitic material.

In further features, a cleaning member is mounted to an outer surface of the rotatable mount and in contact with an inner surface of the window such that as the rotatable mount rotates the cleaning member slides along the inner surface of the window to clean the window.

In further features, the cleaning member includes a cleaning pad configured remove build-up on the inner surface of contaminants released from the bearing.

The present disclosure further provides for, in various features, a light detection and ranging (LiDAR) sensor assembly including: a window; a rotatable mount configured to rotate behind the window; a mirror and a lens mounted to the rotatable mount; a motor configured to rotate the rotatable mount by rotating a shaft connected to the rotatable mount; a bearing configured to support the shaft; and a cleaning member mounted to an outer surface of the rotatable mount and in contact with an inner surface of the window such that as the rotatable mount rotates the cleaning member slides along the inner surface of the window to clean the window.

In further features, the cleaning member includes at least one of a pad, a cloth, and a sponge configured to remove build-up on the inner surface of the window of contaminants released from the bearing.

In further features, the present disclosure includes a contaminant trap extending around the shaft between the bearing and the rotatable mount, the contaminant trap configured to capture contaminants released from the bearing to restrict passage of the contaminants from the bearing to at least one of the mirror and the lens.

In further features, the contaminant trap includes a sorbent material configured to trap vapor released from lubricant included with the bearing.

In further features, the sorbent material includes at least one of: activated carbon, alumina, polyurethane, polyethylene, polypropylene, and a graphitic material.

In further features, the present disclosure includes a light transmitter and a light receiver mounted to the rotatable mount.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an exemplary sensor assembly in accordance with the present disclosure;

FIG. 2 is a cross-sectional view taken along line 2-2 of FIG. 1;

FIG. 3 is a cross-sectional view taken along line 3-3 of FIG. 1;

FIG. 4 is a perspective view of an exemplary contaminant trap of the sensor assembly of FIG. 1; and

FIG. 5 is a cross-sectional view of an additional sensor assembly in accordance with the present disclosure.

In the drawings, reference numbers may be reused to identify similar and/or identical elements.

### DETAILED DESCRIPTION

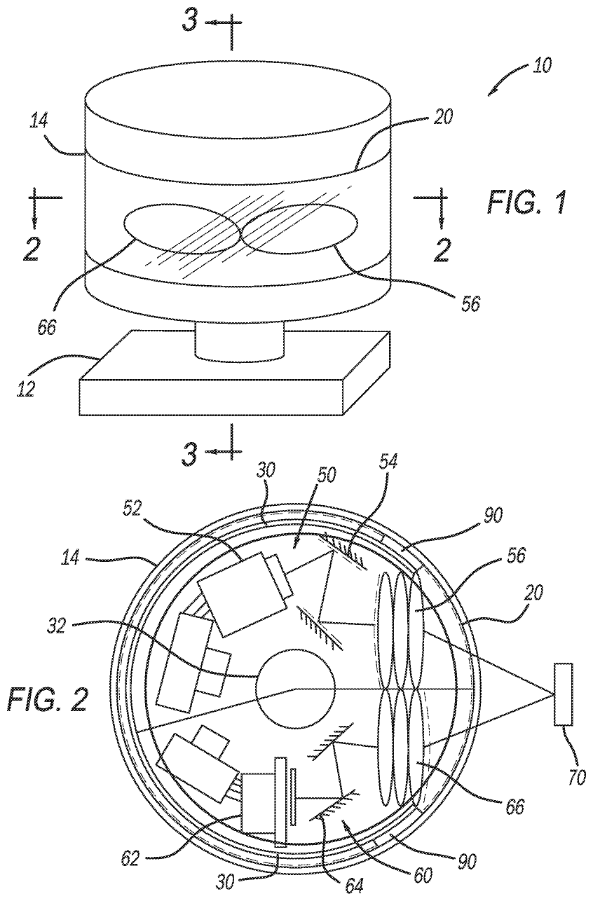

FIG. 1 illustrates an exemplary sensor assembly 10 in accordance with the present disclosure. The sensor assembly 10 is configured as a light detection and ranging (LiDAR) sensor. The sensor assembly may be configured as any other suitable sensor as well. For example, the sensor assembly 10 may be configured as a camera-based sensor, radar-based sensor, etc. The sensor assembly 10 may be configured for use in any suitable application, such as any suitable automotive-based application. Exemplary automotive-based applications include, but are not limited to, autonomous driving applications, advanced driver assistance systems (ADAS), road-mapping applications, etc. The sensor assembly 10 may be configured for any suitable non-automotive use as well.

In the example of FIG. 1, the sensor assembly 10 includes a base 12 and an outer casing 14. In addition to the configuration of FIG. 1, the sensor assembly 10 may be provided in any other suitable form or configuration, particularly any other external form or configuration. For example, the sensor assembly 10 may be configured to be mounted in any suitable manner so as to include a different base 12 or no base 12. Further, the outer casing 14 may have any other suitable shape or be incorporated into a larger sensor mounting assembly. Thus, the configuration of the sensor assembly 10 is for exemplary purposes only.

With continued reference to FIG. 1, and additional reference to FIGS. 2-4, the outer casing 14 of the exemplary sensor assembly 10 includes a window 20, which extends partially, or entirely, around the outer casing 14. The window 20 may be made of any suitable transparent material, such as glass, a polymeric material, etc. Seated within the outer casing 14 is a rotatable mount 30. The rotatable mount 30 may be configured in any suitable manner. For example, the rotatable mount 30 may be configured as a rotatable platform or chamber. The rotatable mount 30 is connected to a shaft 32, which is supported by bearings 42 and is rotatable by a motor 40. The motor 40 may be any suitable motor configured to rotate the shaft 32 and the rotatable mount 30.

The rotatable mount 30 carries various sensor components. In the example illustrated, the rotatable mount 30 includes any suitable transmitting components 50 and any suitable receiving components 60. Exemplary transmitting components 50 include a transmitter 52, transmitting mirrors 54, and transmitting lenses 56. Exemplary receiving components include a receiver 62, receiving mirrors 64, and receiving lenses 66. When the sensor assembly 10 is configured as a LiDAR sensor, the transmitter 52 is configured to transmit a light beam, which is directed by transmitting mirrors 54 to and through the transmitting lenses 56. From the transmitting lenses 56, the light beam exits the sensor assembly 10 through the window 20. The light beam reflects off any suitable object of interest 70 back to the sensor assembly 10. The reflected light beam passes through the window 20 to the receiving lenses 66. From the receiving lenses 66 the light beam is reflected by receiving mirrors 64 to the receiver 62. The amount of time that it takes the light beam to return to the sensor assembly 10 after being reflected by the object of interest 70 is used to determine the distance that the object of interest 70 is from the sensor assembly 10.

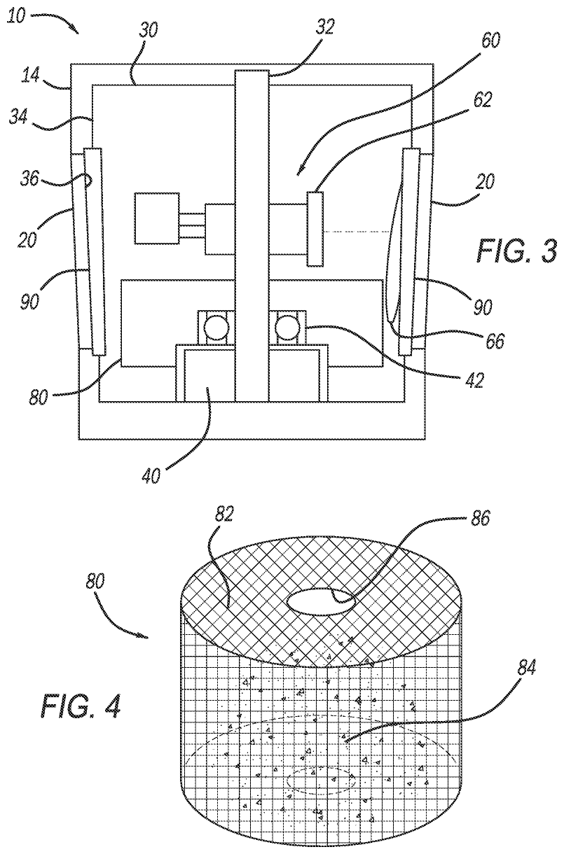

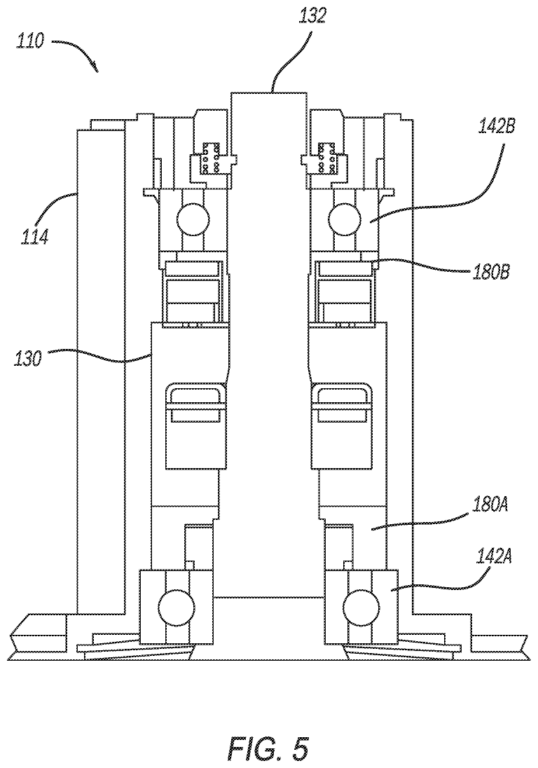

With particular reference to FIGS. 3 and 4, the sensor assembly 10 further includes a contaminant trap 80. The contaminant trap 80 may be mounted within the sensor assembly 10 independent of the rotatable mount 30 such that the contaminant trap 80 remains stationary as the rotatable mount 30 rotates, may be mounted to the rotatable mount 30 so as to rotate with the rotatable mount 30, or mounted in any other suitable manner. The contaminant trap 80 is seated over the bearings 42, and is configured to trap or otherwise contain contaminants that may be released by the bearings 42 so to prevent the contaminants from passing to the window 20, the transmitting components 50, and/or the receiving components 60. For example, the contaminant trap 80 includes any suitable sorbent material configured to trap vapor released from lubricant included with the bearings 42. Any suitable sorbent material may be included with the contaminant trap 80. Exemplary materials include, but are not limited to, the following: activated carbon, alumina, polyurethane, polyethylene, polypropylene, or other high surface area polymeric or graphitic material.

With particular reference to FIG. 4, the contaminant trap 80 in one embodiment includes an outer porous material 82, which defines a housing for the sorbent material 84. The contaminant trap 80 may be generally configured as an annular structure defining a center aperture 86 through which the shaft 32 extends. The contaminant trap 80 is thus seated over the shaft 32 onto the bearings 42 such that the contaminant trap 80 surrounds the shaft 32.

With particular reference to FIGS. 2 and 3, the sensor assembly 10 further includes a cleaning member 90. The cleaning member 90 may be any suitable cleaning member, such as any suitable pad, sponge, cloth, etc. The cleaning member 90 is particularly configured to remove any buildup of contaminants on the inner surface of the window 20, such as contaminants released from the bearings 42.

The cleaning member 90 is mounted to the outer casing 14 such that the cleaning member 90 rotates with the outer casing 14. The cleaning member 90 may be mounted in any suitable manner, such as with any suitable adhesive or mechanical interlock. The cleaning member 90 is positioned so that it is in contact with the window 20. For example, the cleaning member 90 may be mounted to an exterior surface 34 of the rotatable mount 30 to contact an interior surface 36 of the window 20 (see FIG. 3). As the rotatable mount 30 rotates within the outer casing 14, the cleaning member 90 moves along the interior surface 36 of the window 20 to clean the interior surface 36 of any contaminants released from the bearings 42, or any other contaminants deposited on the interior surface 36. Any suitable number of cleaning members 90 may be included. FIG. 2 illustrates two cleaning members 90, for example, on opposite sides of the transmitting lenses 56 and the receiving lenses 66.

FIGS. 1-3 illustrate the sensor assembly 10 as including both the contaminant trap 80 and the cleaning member 90. However, in accordance with the present disclosure, the sensor assembly 10 may include only the contaminant trap 80 or only the cleaning member 90.

FIG. 5 illustrates an additional sensor assembly 110 in accordance with the present disclosure. The sensor assembly 110 is similar to the sensor assembly 10, and thus similar features are designated in FIG. 5 with the same reference numbers used to identify features of the sensor assembly 10, but increased by 100. The description of the sensor assembly 10 also applies to the sensor assembly 110 with respect to the similar features.

Unlike the sensor assembly 10, the sensor assembly 110 includes a lower bearing 142A and an upper bearing 142B, both of which support the shaft 132. The rotatable mount 130 is between the lower bearing 142A and the upper bearing 142B. The rotatable mount 130 is similar to, or the same as, the rotatable mount 30. Thus, the rotatable mount 130 is rotatable within an outer casing 114, and supports the transmitting components 50 and the receiving components 60. The outer casing 114 includes a window, which is similar to, or the same as, the window 20.

The lower bearing 142A is below the rotatable mount 130, and the upper bearing 142B is above the rotatable mount 130. Between the lower bearing 142A and the rotatable mount 130 is a first contaminant trap 180A. Between the upper bearing 142B and the rotatable mount 130 is a second contaminant trap 180B. The first contaminant trap 180A is configured to trap contaminants to prevent contaminants released from the lower bearing 142A from depositing on one or more of the transmitting components 50, the receiving components 60, and the window 20. Similarly, the second contaminant trap 180B is configured to trap contaminants released from the upper bearing 142B from depositing on one or more of the transmitting components 50, the receiving components 60, and the window 20. The first contaminant trap 180A and the second contaminant trap 180B may both be similar to, or the same as, the contaminant trap 80. Thus, the description of the contaminant trap 80 also applies to both the first contaminant trap 180A and the second contaminant trap 180B.

The sensor assembly 110 may also include the cleaning member 90. The cleaning member 90 may be mounted to an outer surface of the rotatable mount 130 in any suitable manner, such as with any suitable adhesive or mechanical interlock. The cleaning member 90 is mounted to contact the window 20. Thus, upon rotation of the rotatable mount 130, the cleaning member 90 mounted to the rotatable mount 130 will wipe across the window 20 to clean the window 20 of any contaminants that may have been released from the lower bearing 142A and/or the upper bearing 142B and deposited onto the window 20.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A sensor assembly comprising:
a rotatable mount;
transmitter components and receiver components supported by the rotatable mount so as to rotate with the rotatable mount;
a motor configured to rotate the rotatable mount by rotating a shaft connected to the rotatable mount;
a bearing configured to support the shaft; and
a contaminant trap between the bearing and each of the transmitter components and the receiver components, the contaminant trap configured to capture contaminants to restrict passage of contaminants from the bearing to the transmitter components and the receiver components.

2. The sensor assembly of claim 1, wherein the transmitter components include at least one of a light beam transmitter, a mirror, and a lens.

3. The sensor assembly of claim 1, wherein the receiver components include at least one of a receiver, a mirror, and a lens.

4. The sensor assembly of claim 1, wherein the sensor assembly is configured as a light detection and ranging (LiDAR) sensor.

5. The sensor assembly of claim 1, wherein the contaminant trap extends around the shaft.

6. The sensor assembly of claim 5, wherein the contaminant trap includes a sorbent material configured to trap vapor released from lubricant included with the bearing.

7. The sensor assembly of claim 5, wherein the contaminant trap includes at least one of activated carbon, alumina, polyurethane, polyethylene, polypropylene, and a graphitic material.

8. The sensor assembly of claim 1, further comprising:
a window, the rotatable mount is seated behind the window; and
a cleaning member mounted to an outer surface of the rotatable mount and in contact with an inner surface of the window such that as the rotatable mount rotates the cleaning member slides along the inner surface of the window to clean the window.

9. The sensor assembly of claim 8, wherein the cleaning member includes a cleaning pad configured to remove build-up on the inner surface of contaminants released from the bearing.

10. A light detection and ranging (LiDAR) sensor assembly comprising:
a window;
a rotatable mount configured to rotate behind the window;
a mirror and a lens supported by the rotatable mount;
a motor configured to rotate the rotatable mount by rotating a shaft connected to the rotatable mount;
a bearing configured to support the shaft; and
a contaminant trap extending around the shaft between the bearing and the rotatable mount, the contaminant trap configured to capture contaminants released from the bearing to restrict passage of the contaminants from the bearing to at least one of the mirror and the lens.

11. The LiDAR sensor assembly of claim 10, further comprising a light transmitter and a light receiver mounted to the rotatable mount.

12. The LiDAR sensor assembly of claim 10, wherein the contaminant trap includes a sorbent material configured to trap vapor released from lubricant included with the bearing, the sorbent material including at least one of: activated carbon, alumina, polyurethane, polyethylene, polypropylene, and a graphitic material.

13. The LiDAR sensor assembly of claim 10, further comprising:
a cleaning member mounted to an outer surface of the rotatable mount and in contact with an inner surface of the window such that as the rotatable mount rotates the cleaning member slides along the inner surface of the window to clean the window.

14. The LiDAR sensor assembly of claim 13, wherein the cleaning member includes a cleaning pad configured remove build-up on the inner surface of contaminants released from the bearing.

15. A light detection and ranging (LiDAR) sensor assembly comprising:
a window;
a rotatable mount configured to rotate behind the window;
a mirror and a lens mounted to the rotatable mount;
a motor configured to rotate the rotatable mount by rotating a shaft connected to the rotatable mount;
a bearing configured to support the shaft; and
a cleaning member mounted to an outer surface of the rotatable mount and in contact with an inner surface of the window such that as the rotatable mount rotates the cleaning member slides along the inner surface of the window to clean the window.

16. The LiDAR sensor assembly of claim 15, wherein the cleaning member includes at least one of a pad, a cloth, and a sponge configured to remove build-up on the inner surface of the window of contaminants released from the bearing.

17. The LiDAR sensor assembly of claim 15, further comprising a contaminant trap extending around the shaft between the bearing and the rotatable mount, the contaminant trap configured to capture contaminants released from the bearing to restrict passage of the contaminants from the bearing to at least one of the mirror and the lens.

18. The LiDAR sensor assembly of claim 17, wherein the contaminant trap includes a sorbent material configured to trap vapor released from lubricant included with the bearing.

19. The LiDAR sensor assembly of claim 18, wherein the sorbent material includes at least one of: activated carbon, alumina, polyurethane, polyethylene, polypropylene, and a graphitic material.

20. The LiDAR sensor assembly of claim 17, further comprising a light transmitter and a light receiver mounted to the rotatable mount.
